(19) United States
(12) Patent Application Publication
(10) Pub. No.: US 2012/0269374 A1
(43) Pub. Date: Oct. 25, 2012

(54) AUTOMATICALLY ADJUSTING HEADPHONES

(76) Inventors: Noel Lee, Las Vegas, NV (US); David Leung, San Mateo, CA (US)

(21) Appl. No.: 13/332,113

(22) Filed: Dec. 20, 2011

Related U.S. Application Data
(60) Provisional application No. 61/430,148, filed on Jan. 5, 2011.

(51) Int. Cl. H04R 1/10

(52) U.S. Cl. 381/379

(57) ABSTRACT

This invention provides continuously adjustable headphones that utilize a ball and socket hinge arrangement that allows the ear cup shell portion of the headphone to rotate in any direction, allowing the speaker housing to articulate about the ball joint in any directional plane to provide comfort and superior acoustic performance.

### CROSS REFERENCE TO RELATED APPLICATIONS

This application claims priority to the filing date of a U.S. provisional patent application having Ser. No. 61/430,148, entitled “Automatically Adjusting Headphones”, filed on Jan. 5, 2011 of which is incorporated herein by reference in their entirety.

### TECHNICAL FIELD

The present invention generally relates to headphones. More particularly, the present invention relates to a system that allows for the automatic physical adjustment of over the ears headphones.

### BACKGROUND ART

There exists in the art a wide variety of headphone designs. However due to the wide variety of shapes and sizes of people that use them, the state of the art has heretofore lacked a simple and elegant way to provide headphones that will instantly and automatically adjust to each user. Since it is important that the angle of the headphone be consistent for both comfort and audio fidelity, there is a need for headphones that provide such qualities.

### DISCLOSURE OF THE INVENTION

The present invention addresses the current needs for an automatically adjustable headphone system. Prior art attempts to provide for adjustable headphones have typically utilized hinge systems that allowed rotation of the headphone about a fixed number of axes. Such systems limit the adjustability of the headphones in that they are only capable of adjustment about a finite number of directions. As such, there exists a need for a headphone that can continuously adjust to any angle.

The headphones described herein utilize a ball and socket hinge arrangement that allows the ear cup shell portion of the headphone to rotate in any direction. This allows the speaker housing to articulate about the ball joint in any directional plane to provide comfort and superior acoustic performance.

### BRIEF DESCRIPTION OF THE DRAWING(S)

FIG. 1 is an exploded view of the invention.

FIG. 2 is a perspective view of the ear cup shell portion of the invention, also showing the attached ball member.

FIG. 3 is another exploded view of the invention, from an alternate perspective, showing the tabs with circular cutouts attached to the interior side of the speaker housing.

FIG. 4 is a side view of the invention.

FIG. 5 is a perspective view of the interior side of the speaker housing portion of the invention.

FIG. 6 provides a perspective view of the exterior portions of the headphones.

FIG. 7 is a perspective view of the ball and socket hinge joint.

FIG. 8 shows an alternate embodiment where the ball joint is attached to the speaker housing and the tabs are attached to the ear cup shell.

### DETAILED DESCRIPTION OF THE INVENTION

For a better understanding of the present invention, reference is made to the below referenced accompanying Drawing(s). Reference numbers refer to the same or equivalent parts of the present invention throughout the several figures of the Drawing(s).

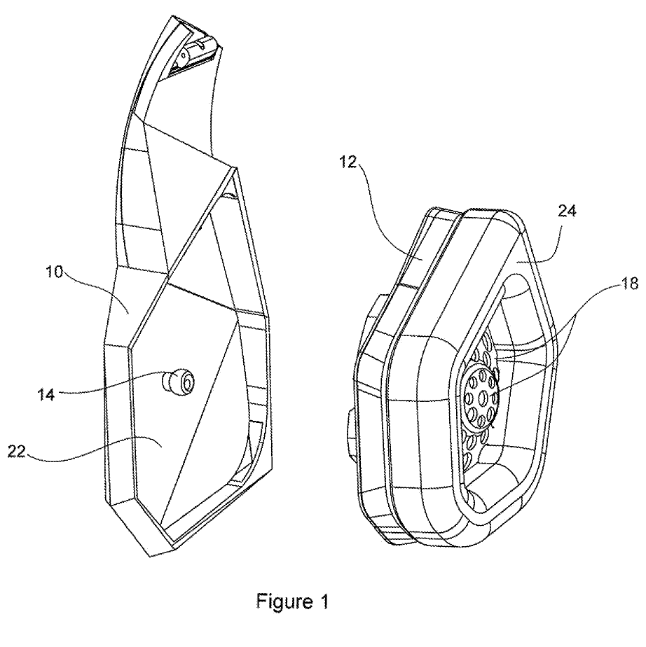

FIG. 1 is an exploded view of an embodiment of the headphone structure, including the ear cup shell 10. In a preferred embodiment, there will be an ear cup shell 10 at each end of the headphone, connected by a headphone band 30 that will typically be worn over the user's head. As such, there will be two ear cup shells 10 and two speaker housings 12 for each headphone unit. The ear cup shell 10 portion of the headphone is shown having an interior and an exterior portion. The interior portion of the ear cup shell (shown in FIG. 1) will not typically be visible when the speaker housing 12 is attached to the ear cup shell 10.

The ball member 14 is shown extending out from the ear cup shell 10 in a generally perpendicular angle. The end of the ball member 14 will preferably have a generally spherical shape, which allows it to act as a ‘ball’ in a ball and socket hinge. The headphone speakers 18 are shown within the speaker housing 12. Preferably, the exterior sides of the speaker housing 24 should lay flush against the user's ear or head, depending on the size of the housing. Also shown is the interior side 22 of the ear cup shell.

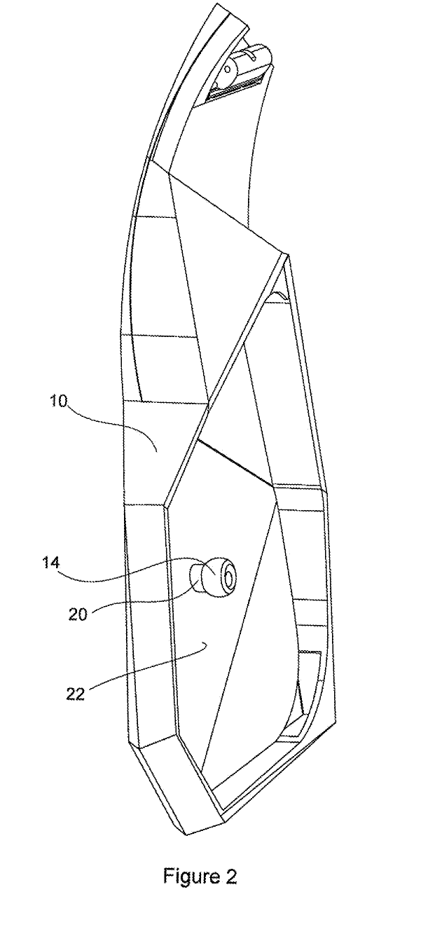

FIG. 2 shows the interior portion of the ear cup shell 10, as well as the ball member 14. An attachment piece 20 protrudes from the interior side 22 of the ear cup housing 10.

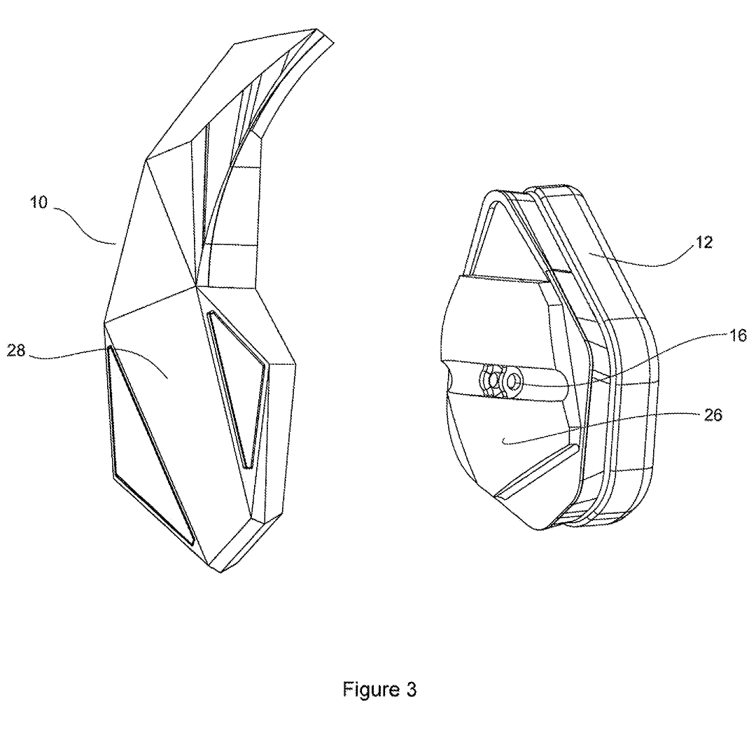

FIG. 3 shows a side/rear perspective view of both the ear cup shell 10 and the speaker housing 12. Also shown here are the parallel tabs 16. Each of the tabs 16 has a circular cutout. These tabs 16, with the circular cutouts act as a socket member. This socket member will be sized so as to allow the ball member 14 to fit between the tabs 16 and be in functional contact with them to create a hinge that allows for rotational movement along any plane. In use, the ball member 14 and the socket tabs that create the socket member 16 will preferably be hidden from view and internal to the headphone.

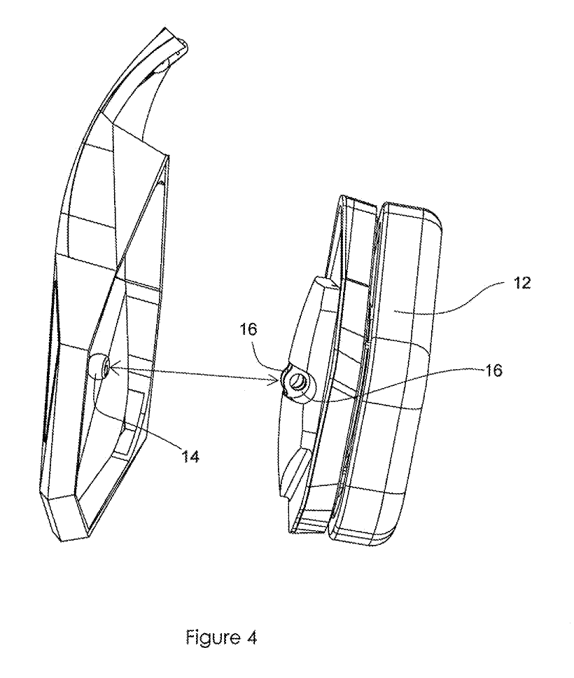

FIG. 4 is an exploded view of the invention. This view attempts to show how the ball member 14 will fit into the socket 16 created by the tabs when the ear cup shell 10 and the speaker housing 12 are pressed together when assembled.

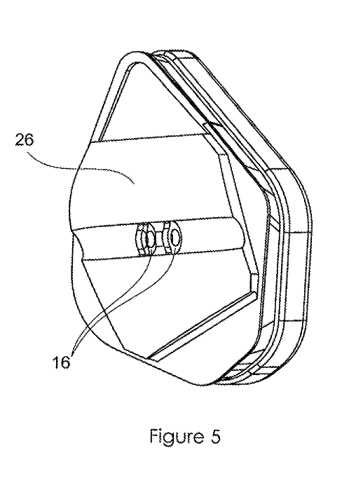

FIG. 5 is a perspective view of the interior side of the speaker housing portion of the invention.

The tabs 16 with the circular cutouts are shown. These tabs 16 are generally parallel to each other and include circular cutouts within the tabs 16 that allow the ball member 14 to be located between the tabs and within the circular cutouts such that the ball member 14 can remain in contact with the tabs and provide a hinge and connection between the ear cup shell 10 and the speaker housing 12. This arrangement allows the ball member 14 and the socket 16 (parallel tabs with circular cutouts), to act as a ball and socket hinge joint, allowing the speaker housing 12 to rotate in any directional plane.

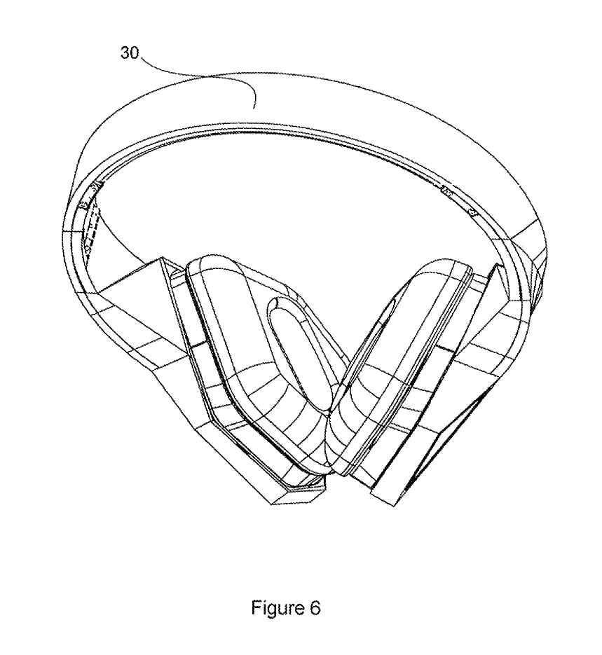

FIG. 6 provides a perspective view of the exterior portions of the headphones. The headphones are connected to each other by a headband 30, which will typically be worn on the user's head.

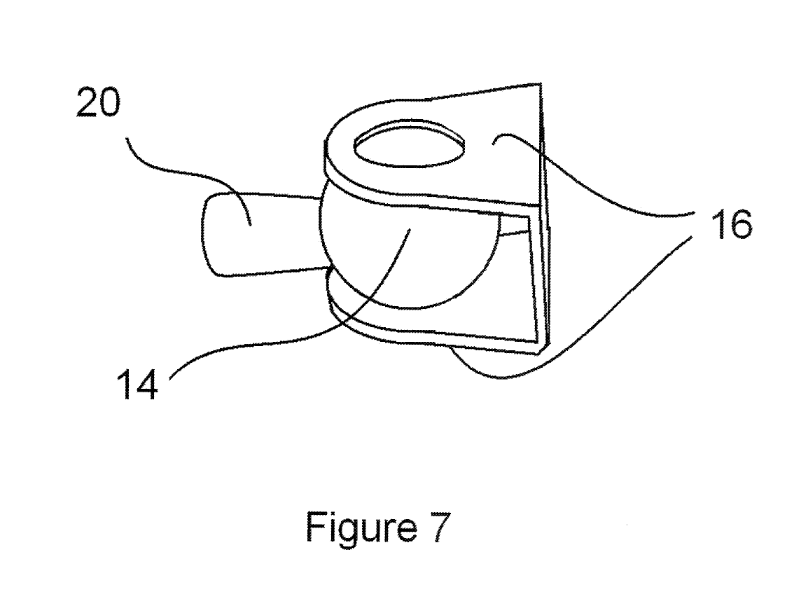

FIG. 7 is a magnified view of the ball and socket hinge joint created when the ball member 14 is located between the tabs 16. In this configuration, the ball and socket hinge joint can be rotated in any directional plane to create the ideal angle of the speaker housing 12 against the user's head/ear. The attachment piece can be used to attach the ball member to the interior of either the ear cup shell or the speaker housing, depending on the configuration.

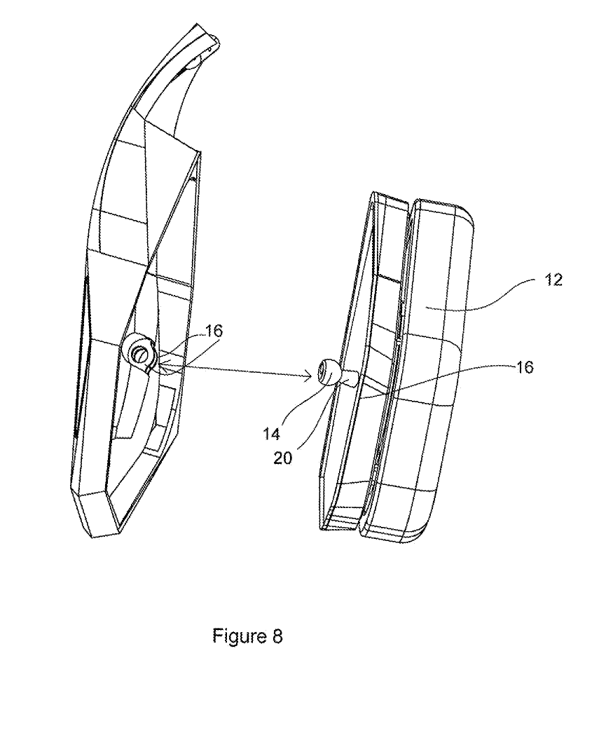

FIG. 8 shows an alternate embodiment, where the location of the ball member 14 and the socket/tabs 16 are reversed, such that the ball member 14 protrudes from the speaker housing 12 and the tabs/socket member 16 protrude from the ear cup shell 10.

What is claimed:

1. A self-adjusting headphone comprising:
A. An ear cup shell member comprising;
1. An interior side;
2. An exterior side; and
B. A generally spherically shaped ball member attached to and protruding from the interior side of the ear cup shell member;
C. A speaker housing comprising:
1. An interior side;
2. An exterior side; and
D. Two generally parallel tabs attached to and protruding from the interior side of the speaker housing, wherein each tab has a circular cutout so that the two tabs create a socket hinge joint; and
E. Wherein the ball member and the socket member are sized such that the ball member and socket member are in functional contact with each other creating a ball and socket hinge joint.

2. A self-adjusting headphone comprising:
A. A speaker housing comprising:
1. An interior side;
2. An exterior side; and
B. A generally spherically shaped ball member attached to and protruding from the interior side of the speaker housing;
C. An ear cup shell member comprising;
1. A interior side;
2. A exterior side; and
D. Two generally parallel tabs attached to and protruding from the interior side of the ear cup shell member, wherein each tab has a circular cutout so that the two tabs create a socket hinge joint; and
E. Wherein the ball member and the socket member are sized such that the ball member and socket member are in functional contact with each other creating a ball and socket hinge joint.

3. The self-adjusting headphone of claim 1, comprising two self-adjusting headphones connected to each other by a headband of a size and shape suitable for wearing on a person's head.

4. The self-adjusting headphone of claim 2, comprising two self-adjusting headphones connected to each other by a headband of a size and shape suitable for wearing on a person's head.

5. The self-adjusting headphone of claim 1, further comprising an attachment piece coupled to the ball member and connected to the interior side of the ear cup shell.

6. The self-adjusting headphone of claim 2, further comprising an attachment piece coupled to the ball member and connected to the interior side of the speaker housing.
